(19) United States
(12) Patent Application Publication
(10) Pub. No.: US 2025/0131907 A1
(43) Pub. Date: Apr. 24, 2025

(54) HEADPHONE CONTROL METHOD AND HEADPHONE

(71) Applicant: Anker Innovations Technology Co., Ltd., Changsha (CN)

(72) Inventors: Xianpeng Ling, Shenzhen (CN); Haiping Cheng, Shenzhen (CN); Kun Han, Shenzhen (CN)

(21) Appl. No.: 18/903,757

(22) Filed: Oct. 1, 2024

(30) Foreign Application Priority Data
Oct. 23, 2023 (CN) 202311381433.1

(51) Int. Cl. G10K 11/178; G10L 25/93; H04R 1/10

(52) U.S. Cl. CPC G10K 11/17837; G10L 25/93; H04R 1/1083

(57) ABSTRACT

A headphone control method and a headphone are disclosed. By simultaneously turning on an active noise cancellation link and a first transparent transmission link, external audio signals may be suppressed by generating anti-noise signals by the active noise cancellation link and playing the anti-noise signals by the speaker. Also, a non-target-type audio signal may be removed or filtered by performing noise reduction processing on the non-target-type audio signal in the external audio signals by the first transparent transmission link to obtain the noise-reduced audio signal in which the target-type audio signal in the external audio signals is retained. The speaker plays the noise-reduced audio signal, so that the target-type audio signal can be transparently transmitted to a user's ears, and the user can focus on the audio signals of the target type that they desire to perceive.

### CROSS-REFERENCE TO RELATED APPLICATION(S)

This Application claims the benefit of Chinese Application 202311381433.1 filed on Oct. 23, 2023, the entire contents of which are incorporated herein by reference.

### TECHNICAL FIELD

The present disclosure relates to the field of audio technology, particularly to a headphone control method and a headphone.

### BACKGROUND ART

In recent years, usage of headphones by users has grown rapidly. As demand for sound quality increases, demand for noise-cancelling headphones also increases.

In terms of noise reduction methods, noise-cancelling headphones can be divided into active noise-cancelling headphones and passive noise-cancelling headphones. With improvement in noise reduction quality of headphones, people usually need to take off headphones during use in order to perceive ambient sounds, and wear the headphones again when there is no need for perception. Therefore, noise-cancelling headphones in the related art have a problem of cumbersome operations when a user needs to perceive an external environment.

### SUMMARY

In view of the above, a headphone control method, a headphone control device, a headphone, a computer-readable storage medium, and a computer program product capable of improving convenience of operation in response to the above technical problem are provided.

In a first aspect, the present disclosure provides a headphone control method including: simultaneously turning on an active noise cancellation link and a first transparent transmission link;
acquiring external audio signals;
performing active noise cancellation processing on the external audio signals by the active noise cancellation link to obtain anti-noise signals, and playing the anti-noise signals by a speaker; and
performing noise reduction processing on a non-target-type audio signal in the external audio signals by the first transparent transmission link to obtain a noise-reduced audio signal, and playing the noise-reduced audio signal by the speaker.

In a second aspect, the present disclosure provides a headphone control device including:
a control module configured to simultaneously turn on an active noise cancellation link and a first transparent transmission link;
an acquisition module configured to acquire external audio signals;
an active noise cancellation module configured to perform active noise cancellation processing on the external audio signals by the active noise cancellation link to obtain anti-noise signals, and play the anti-noise signals by a speaker; and
a selective transparent transmission module configured to perform noise reduction processing on a non-target-type audio signal in the external audio signals by the first transparent transmission link to obtain a noise-reduced audio signal, and play the noise-reduced audio signal by the speaker.

In a third aspect, the present disclosure provides a headphone including a microphone and a controller connected with the microphone, the controller including a processor and a memory, the memory storing a computer program, in which the processor implements steps of the method of the above examples when executing the computer program.

In a fourth aspect, the present disclosure provides a computer-readable storage medium in which a computer program is stored. The processor implements steps of the method of the above examples when executing the computer program.

In a fifth aspect, the present disclosure provides a computer program product including a computer program. The processor implements steps of the method of the above examples when executing the computer program.

By simultaneously turning on the active noise cancellation link and the first transparent transmission link, the above headphone control method, headphone control device, headphone, computer-readable storage medium, and computer program product, are capable of suppressing the external audio signals by generating anti-noise signals by the active noise cancellation link and playing the anti-noise signals by the speaker, and are capable of removing the non-target-type audio signal by performing the noise reduction processing on a non-target-type audio signal in the external audio signals by the first transparent transmission link to obtain the noise-reduced audio signal in which the target-type audio signal in the external audio signals is retained. The speaker plays the noise-reduced audio signal, so that the target-type audio signal can be transparently transmitted to the ears of the user, and the user can focus on the audio signals of the target type that he or she wants to perceive. By adopting this method, when there is a need to perceive the target-type audio signal in the external audio signals, the user does not need to perform cumbersome operations, which improves the convenience of using the headphone.

### BRIEF DESCRIPTION OF THE DRAWINGS

FIG. 1 is a schematic diagram showing application environments of a headphone control method according to an illustrative example;

FIG. 2 is a flow chart showing a headphone control method according to an illustrative example;

FIG. 3 is a flow diagram showing selective transparent transmission steps according to an illustrative example;

FIG. 4 is a schematic diagram showing a principle of volume adjustment according to an illustrative example;

FIG. 5 is a schematic diagram showing an environment selection interface according to an illustrative example;

FIG. 6 is a schematic diagram showing a target type setting interface according to an illustrative example;

FIG. 7 is a flow chart showing a headphone control method according to an illustrative example;

FIG. 8 is a schematic diagram showing active noise cancellation according to an illustrative example;

FIG. 9 is a schematic diagram showing noise reduction capabilities of different noise reduction methods according to an illustrative example;

FIG. 10 is a structural block diagram of a headphone control device according to an illustrative example; and

FIG. 11 is an internal structure diagram of a headphone according to an illustrative example.

### DETAILED DESCRIPTION

In order to make the purpose, technical solutions and advantages of the present disclosure more clearly understood, the following is a further detailed description of the present disclosure in conjunction with the accompanying drawings and illustrative examples. It should be understood that the specific examples described herein are only for the purpose of explaining the present disclosure and are not intended to limit the present disclosure.

Noise-canceling headphones refer to headphones capable of reducing ambient noise. In terms of noise reduction methods, the noise-cancelling headphones can be divided into active noise-cancelling headphones and passive noise-cancelling headphones. Passive noise cancellation reduces sounds transmitted to ears by blocking ambient noise through a physical barrier. Active noise cancellation achieves noise reduction by generating sound waves opposite in phase to the ambient noise and then neutralizing the noise. The active noise cancellation has a good noise reduction effect. When an active noise-cancelling mode is turned on, a user cannot effectively perceive ambient sounds.

In consideration of demands for both noise reduction and ambient sound perception when a user wears a headphone, some headphones support a transparent transmission mode, in which ambient sounds can be transmitted to the headphone. In the transparent transmission mode, ambient sounds can be heard through the headphone, and the demand for perceiving ambient sounds in specific environments can be met. In the transparent transmission mode, all the ambient sounds are truly transmitted to the headphone, so that people gain auditory perception as if they were not wearing the headphone. When a user turns on the transparent transmission mode, ambient noise, sudden loud noise, or human voices can be transmitted to the ears, which results in the user not being able to focus on the sounds he wants to hear.

In view of this problem, the disclosure provides a headphone control method including the following steps: simultaneously turning on an active noise cancellation link and a first transparent transmission link; acquiring external audio signals; performing active noise cancellation processing on the external audio signals by the active noise cancellation link to obtain anti-noise signals, and playing the anti-noise signals by a speaker; and performing noise reduction processing on a non-target-type audio signal in the external audio signals by the first transparent transmission link to obtain a noise-reduced audio signal, and playing the noise-reduced audio signal by the speaker. This method is capable of suppressing the external audio signals by generating the anti-noise signals for the external audio signals by the active noise cancellation link, and is capable of removing or filtering the non-target-type audio signal and retaining a target-type audio signal by performing noise reduction processing on the non-target-type audio signal in the external audio signals by the first transparent transmission link. As a result, the anti-noise signals and the noise-reduced audio signal can be superposed for transparent transmission of the target-type audio signal, and finally, only the target-type audio signal in the external audio signals can be transmitted to the ears of the user, and the user can focus on the target-type audio signal that he or she wants to perceive. By adopting this method, when there is a need to perceive the target-type audio signal in the external audio signals, the user does not need to perform cumbersome operations, which improves the convenience of using the headphone.

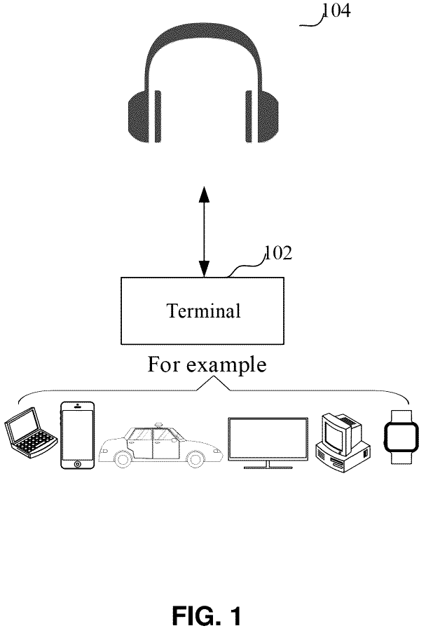

FIG. 1 shows a schematic diagram of an implementation environment provided by an illustrative example of the disclosure, in which the implementation environment includes a terminal 102 and a headphone 104.

The terminal 102 may be, but is not limited to, various personal computers, a laptop, a smartphone, a tablet computer, an Internet of Things (IoT) device, and/or a portable wearable device. The IoT device may be a smart speaker, a smart television, a smart air conditioner, smart on-board equipment, or the like. The portable wearable device may be a smart watch, a smart bracelet, a headset, or the like.

In some examples, an application program having an audio playing function may be installed in the terminal 102. The headphone 104 can be communicatively connected to the terminal 102. The headphone 104 is an electronic device having an audio playing function, and the electronic device may be a headphone, an earmuff headphone, an in-ear headphone, a half-in-ear headphone, or the like, which is not limited in the present example.

After the terminal 102 is communicatively connected to the headphone 104 via a data communication link, the user can control the headphone 104 to play audio by performing specific operations on the terminal 102.

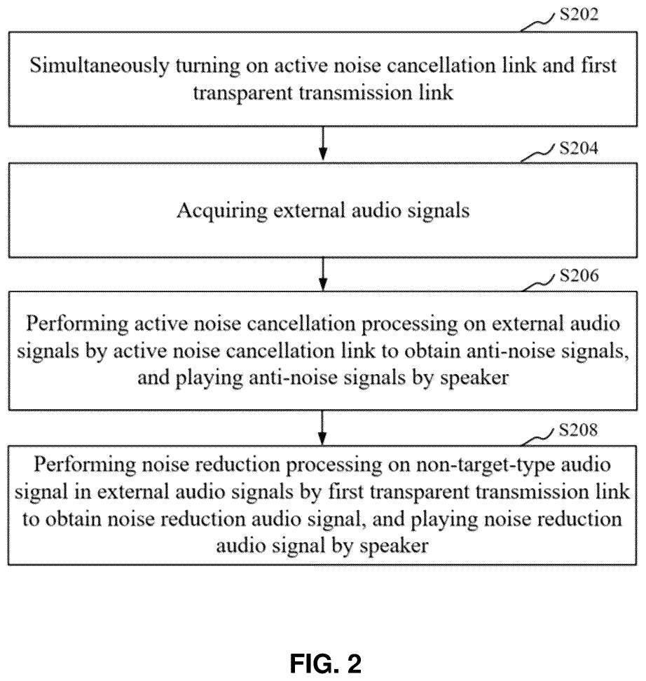

As shown in FIG. 2, an example of a headphone control method, which is applied to the headphone in FIG. 1, is provided. The method includes the following steps.

Step 202 involves simultaneously turning on an active noise cancellation link and a first transparent transmission link.

The active noise cancellation link may be used to achieve active noise cancellation of external audio signals. The first transparent transmission link may be used to achieve transparent transmission of a target-type audio signal in the external audio signals. By simultaneously turning on the active noise cancellation link and the first transparent transmission link, the target-type audio signal can be transparently transmitted while the active noise cancellation is performed.

Next, Step 204 involves acquiring external audio signals.

The external audio signals may refer to audio signals acquired by a microphone of the headphone. The microphone may be located outside the headphone or inside an earmuff, and may be provided as close to ears of the user as possible. The microphone, which may be built in the headphone, captures ambient noise signals in a surrounding environment.

Contents of the external audio signals relate to an environment where the user is located. For example, when the user is in an outdoor environment near a road, the external audio signals are usually traffic noise. In another example, when the user is in an indoor environment, the external audio signals may be human voices and the like.

After acquiring the external audio signal, Step 206 involves performing active noise cancellation processing on the external audio signals by the active noise cancellation link to obtain anti-noise signals, and playing the anti-noise signals by the speaker.

In an example, in order to improve a noise reduction effect, active noise cancellation and passive noise cancellation can be combined to obtain anti-noise signals.

A principle of passive noise cancellation with headphones is based on a principle of physical isolation. The passive noise cancellation does not rely on electronic technology or active disturbance, but reduces the spread of ambient noise with the structures and materials of the headphones. The passive noise cancellation can be achieved by, for example, an earmuff structure, an ear cushion material, and a sound insulation material of the headphones.

The headphone may adopt an earmuff structure, which is a part covering the outside of the headphone. The earmuff may be made of a firm material having a certain density. This structure can block ambient noise from entering the space in the headphone. An ear cushion may be a part of a headphone which comes into contact with an ear, and usually adopts a soft material such as memory foam or sponge to provide a comfortable wearing experience. In addition to comfort, a primary role of the ear cushion can be to create a sealed environment that isolates ambient noise outside. Various sound insulation materials, such as sound-absorbing cotton or a sound insulation layer, may be used in an internal structure of the headphone. These materials can absorb and reduce noise spread, and reduce the disturbance of ambient noise to the sound being delivered via the headphone.

By combining the structures and materials described above, the headphone can reduce the disturbance of ambient noise to a certain extent, so that the microphone acquires external audio signals with reduced noise disturbance. Then, the external audio signals captured by the microphone are sent to a circuit system of the headphone for processing. A digital signal processing algorithm, noise analysis and anti-phase signal generation may be performed on these signals to obtain anti-noise signals.

The digital signal processing algorithm includes operations such as filtering, amplification, and phase adjustment. The noise analysis may include spectrum analysis and feature extraction, by both of which features of the external audio signals such as frequency components, amplitude, and phase can be identified. Specifically, based on a noise analysis result, the active noise cancellation may use the circuit system of the headphone to generate sound wave signals opposite in phase to the external audio signals, which are called anti-phase signals or anti-noise signals having a phase opposite to that of the external audio signals. The external audio signals are mixed with the anti-noise signals via the headphone, and then played by the speaker of the headphone. Since the anti-noise signals have a phase opposite to that of the external audio signals, interference occurs to attenuate or cancel out the noise signals, and thus the sounds heard by the user are clearer and not disturbed.

After Step 206, Step 208 involves performing the noise reduction processing on a non-target-type audio signal in the external audio signals by the first transparent transmission link to obtain a noise-reduced audio signal, and playing the noise-reduced audio signal by the speaker.

The target-type audio signal may refer to an audio signal that the user is concerned about among the external audio signals. The target-type audio signal may include a plurality of types, such as human voices, station public address announcements in a traffic environment, horn sounds in a traffic environment, and public address announcements in a flight/station waiting environment. In an example, the target-type audio signal may be of at least one type.

The target-type audio signal may be at least one type of preset audio signal, such as human voices. The target-type audio signal may also be at least one preset type of audio signal associated with an environment feature, and the type of the target-type audio signal changes as the environment changes. For example, in an environment A, the target-type audio signal includes human voices, and in an environment B, the target-type audio signal includes human voices and horn sounds.

By performing the noise reduction processing on the non-target-type audio signal in the external audio signals by the first transparent transmission link, the non-target-type audio signal in the external audio signals can be reduced or eliminated, so that the obtained noise-reduced audio signal only retains the target-type audio signal, that is, the audio signal that the user is concerned about. The noise-reduced audio signal is played by the speaker, and the target-type audio signal is transparently transmitted to ears of the user through the headphone.

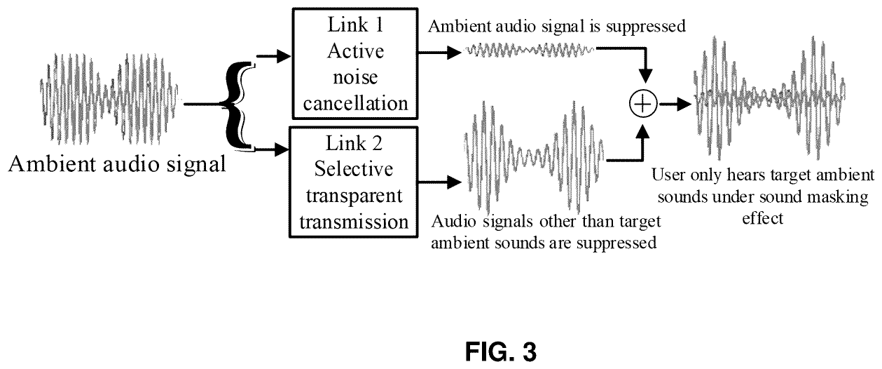

For ease of description, the active noise cancellation link may be referred to as a processing link 1, and the first transparent transmission link may be referred to as a processing link 2. Both of the processing links operate simultaneously. As shown in FIG. 3, the processing link 1 and the processing link 2 are independent of each other, do not affect each other, and operate simultaneously. The processing link 1 implements the active noise cancellation method, and performs the active noise cancellation processing on the external audio signals to obtain the anti-noise signals. The external audio signals can be suppressed by processing of the processing link 1. The processing link 2 implements a selective noise reduction algorithm, and performs the noise reduction processing on a non-target-type audio signal in the external audio signals by the first transparent transmission link to obtain a noise-reduced audio signal. The non-target-type audio signal can be suppressed by processing of the processing link 2. By processing of the processing link 1 and the processing link 2, only the target-type audio signal can be transparently transmitted to the ears of the user while active noise cancellation is achieved.

By processing of the processing link 1, sounds may be substantially reduced, but by processing of the processing link 2, sounds are louder than sounds processed by the processing link 1. When the active noise cancellation link and the first transparent transmission link are simultaneously turned on, due to a hearing masking effect of human ears (masking in audiology refers to the concept that a sensory threshold of human ears to a sound rises due to presence of another sound. For example, human ears can distinguish slight sounds in a silent environment, but these slight sounds are drowned out by noise in a noisy environment. An auditory sense of a weak sound (masked sound) is affected by another strong sound (masking sound), which is called the masking effect of human ears), the human ears cannot perceive the sounds processed by the processing link 1 with a low delay, and thus the user only perceives the retained target-type audio signal.

In the present example, the active noise cancellation processing is performed on the external audio signals by the processing link 1 to obtain the anti-noise signals. The noise reduction processing is performed on the non-target-type audio signal in the external audio signals by the processing link 2 to only retain the target-type audio signal, allowing the user to hear the target-type audio signal under a sound masking effect.

The headphone control method allows the user to keep the headphone on their head when there is a possibility of ambient sounds being present, and allows for the target-type audio signal to be transparently transmitted while the active noise cancellation is performed, thereby improving convenience of operation. For example, when a headphone user has a conversation, human voices present in the external audio signals can be retained by taking human voices as the target-type audio signal, and when using the headphone, the user can also perceive the human voices in the external environment, and can perceive what is being spoken in the external environment without taking off the headphone. For example, when the headphone user needs to perceive a public address announcement while waiting in a station (such as in a train station, bus station, airport, or the like), the announcement may be taken as a target-type audio signal, and then announcements in the external audio signals can be retained. When using the headphone, the user can perceive the contents of the announcement without having to take off the headphone and thus can avoid missing external announcements. For example, when the headphone user desires to hear an announcement in a public transportation environment (e.g., on board a train), the announcement can be taken as a target-type audio signal, and then the announcement in external audio signals can be retained. When using the headphone, the user can also perceive an announcement, and can perceive contents of the announcement without taking off the headphone so as to avoid getting off at a wrong station and other situations.

At least one target-type audio signal that the user is concerned about can be set by the user. For example, when there is a need to perceive ambient sounds, the user selects a target-type audio signal to be concerned about via a headphone control program in the terminal. Thus, the user can flexibly set the target-type audio signals to be concerned about based on personal needs.

The at least one target-type audio signal with which the user is concerned about can also be matched based on environments. For example, an environment feature is determined according to at least one of an environment where the user is located and an application state, and then a corresponding target-type audio signal is matched according to the environment feature. Thus, it is possible to flexibly match a target-type audio signal with which the user is concerned about according to at least one of the environment where the user is located and the application state.

In an example, a noise reduction model may be invoked to perform the noise reduction processing on a non-target-type audio signal in external audio signals.

By simultaneously turning on the active noise cancellation link and the first transparent transmission link, the headphone control method according to the disclosure is capable of suppressing the external audio signals by generating anti-noise signals by the active noise cancellation link and playing the anti-noise signals by the speaker. The method is capable of removing or filtering the non-target-type audio signal by performing the noise reduction processing on a non-target-type audio signal in the external audio signals by the first transparent transmission link to obtain the noise-reduced audio signal in which the target-type audio signal in the external audio signals is retained. The speaker plays the noise-reduced audio signal, so that the target-type audio signal can be transparently transmitted to the ears of the user, and the user can focus on the audio signals of the target type that they desire to perceive. By adopting this method, when there is a need to perceive the target-type audio signal in the external audio signals, the user does not need to perform cumbersome operations, which improves the convenience of using the headphone.

In another example, the first transparent transmission link includes the noise reduction model, and performing noise reduction processing on a non-target-type audio signal in the external audio signals to obtain a noise-reduced audio signal includes: determining at least one target type of audio signals to be transparently transmitted; and performing the noise reduction processing on the non-target-type audio signal in the external audio signals using the noise reduction model to obtain the noise-reduced audio signal.

In an example, a target type of audio signals of concern can be set by the user, and the target type of the audio signals of concern corresponding to an environment can also be matched and determined according to the environment. Specifically, an environment feature can be determined according to at least one of an environment where the user is located and an application state, and audio signals of the corresponding target type can be matched according to the environment feature.

In the present example, the noise reduction model is invoked to perform the noise reduction processing on the non-target-type audio signal in the external audio signals. The noise reduction model can be obtained by training a training data set. The training data set includes input signals with noise and corresponding target-type audio signals, and the target-type audio signals are a labeling result of the input signals with noise. It can be understood that a corresponding training data set needs to be prepared for different target-type audio signals. Then, a lightweight causal model is built. The model receives frequency domain features of the input signals with noise, and outputs amplitude spectrum information on a piece of enhanced speech of predicted target-type audio signals. A model training process includes calculating a loss function according to a deviation between the labeled target-type audio signals and the predicted target-type audio signals, and performing iterative training based on the loss function. The loss function is used to measure a difference between the predicted target-type audio signals and the labeled target-type audio signals. Commonly used loss functions include mean square error (MSE), structural similarity index (SSIM), and the like, and these loss functions can measure a degree of difference between predicted signals and real signals.

In a specific training process, a training data set and a defined loss function are used to train the model through an optimization algorithm (such as gradient descent). The model constantly adjusts internal parameters, so that the difference between the predicted target-type audio signals and the labeled target-type audio signals is minimized. During the training process, model parameters can be updated using methods such as batch training or stochastic gradient descent. After the model training is completed, convergence is achieved, and the noise reduction model is obtained. The noise reduction model receives input signals with noise (such as the external audio signals), makes a prediction based on the learned features and parameters, and outputs signals after noise reduction, that is, at least one target type of audio signals.

In the present example, the noise reduction model is used to perform the noise reduction processing on the non-target-type audio signal in the external audio signals. Compared with a noise reduction method based on spectrum features and the like, this method can effectively remove or filter ambient noise other than the target-type audio signal, including other sudden noise in the external environment, and thus sudden noise is avoided from frightening the user during transparent transmission.

In an example, before the step of invoking the noise reduction model and performing the noise reduction processing on the non-target-type audio signal in the external audio signals to obtain the noise-reduced audio signal, this method further includes: preprocessing the external audio signals.

The preprocessing may include at least one of framing processing, windowing processing, frequency domain conversion processing, and compression.

The framing processing is to divide a speech signal into multiple segments to analyze feature parameters thereof. Each segment is called a frame, and a frame usually spans 10 milliseconds to 30 milliseconds. Apiece of speech has features of being short-term and steady, and it is easier to estimate features of steady periodic signals.

In order to reduce a spectral leakage phenomenon caused by discontinuity between frames in the framing process, the windowing processing may be performed on framed data. After framing, each frame exhibits abrupt changes at both ends, which can result in spectral leakage and lead to inaccurate spectrum analysis results. In the windowing process, a frame signal may be gradually attenuated from having a signal value to zero by applying a window function to each frame, which can make a connection between frames smoother and reduce the occurrence of leakage phenomenon.

The frequency domain conversion processing converts an external audio signal from a time domain to a frequency domain. The frequency domain conversion processing may be performed using Fourier transform.

Dynamic feature compression can reduce a dynamic range of compression features and reduce a model processing pressure. A range of dynamic compression is generally obtained by taking a logarithm or extracting a square root.

Before the processing, by invoking the noise reduction model, the above preprocessing may be performed on the external audio signals to obtain audio signals that meet a model processing requirement, so that the preprocessed external audio signals are input to the noise reduction model for processing.

After the step of invoking the noise reduction model and performing the noise reduction processing on a non-target-type audio signal in the external audio signals to obtain a noise-reduced audio signal, an output adjustment may be performed on the noise-reduced audio signal to obtain an adjusted noise-reduced audio signal. The output adjustment includes at least one of a volume adjustment and an audio equalization adjustment. The step of playing the noise-reduced audio signal by the speaker includes: playing the adjusted noise-reduced audio signal via the speaker.

The noise reduction model includes a large number of parameters, and has a noise reduction capability after a large amount of data training. The model can receive external audio signals, and output enhanced speech signals of predicted target-type audio signals.

By performing the output adjustment on predicted speech signals, output quality of audio signals of concern in the at least one target type of audio signals can be improved. The output adjustment may include one or more of equalizer (EQ) adjustment or volume adjustment.

Specifically, the volume adjustment may include performing volume mapping processing on the predicted speech signals to adjust an output volume of the predicted speech signals. Specifically, the volume adjustment may adopt a wide dynamic range compression (WDRC) algorithm. The WDRC algorithm can dynamically adjust a gain and a compression ratio of a signal according to a volume level of the signal and set compression parameters.

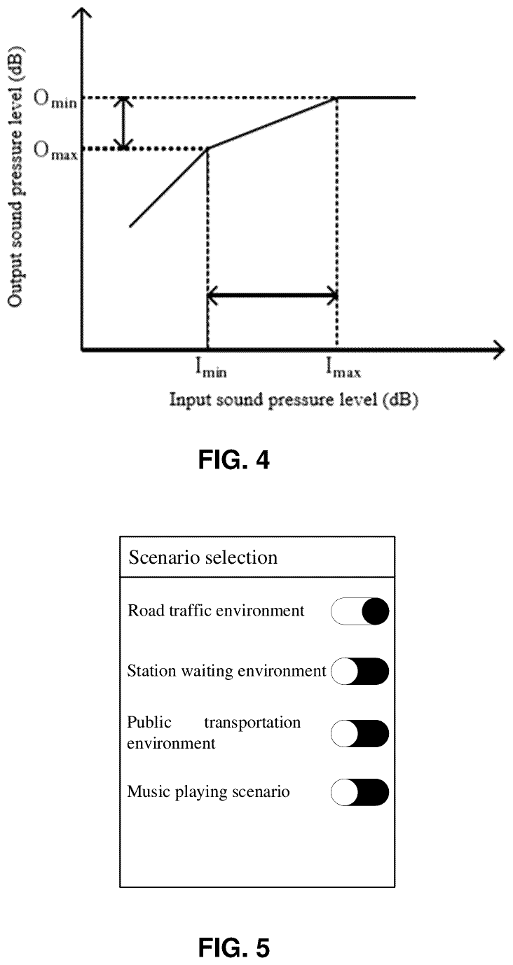

The WDRC algorithm is shown in FIG. 4. I_min and I_max represent a hearing threshold and a pain threshold of a normal person, and O_min and O_max represent a hearing threshold and a pain threshold of a patient, respectively. When a sound pressure level of a piece of received speech is lower than the hearing threshold I_min, a human ear cannot perceive this part of speech, and the WDRC algorithm does not process the speech signal. When the sound pressure level of a piece of received speech is greater than the pain threshold I_max, the sound pressure at this time exceeds a limit that the human ear can bear, and the WDRC algorithm sets a gain of this part of a speech signal to 0. When the sound pressure level of the received speech is between the hearing threshold I_min and the pain threshold I_max, the WDRC algorithm is linearly matched to a target dynamic range, thereby achieving the dynamic compression at a whole sound pressure level. The sound pressure level of the compressed speech falls exactly within a dynamic hearing range of the patient. The dynamic range of the compressed speech signal becomes narrow at most frequencies, but for a patient with hearing loss, speech quality is higher, and a purpose of a loudness compensation algorithm can be achieved.

Based on the WDRC algorithm, in the present example, the volume mapping processing is performed on the predicted speech signals to adjust the output volume of the predicted speech signals. Specifically, when the sound pressure level of the predicted speech signals exceeds I_max, a speaker volume is lowered mainly for hearing protection. When the sound pressure level of the predicted speech signals is lower than I_min, the speaker volume is slightly amplified to keep the perception of the external environment for the user.

Specifically, audio equalization processing is used to adjust gains of audio signals in different frequency ranges to change a frequency response of sounds. The audio equalization processing can increase or decrease signal energy in a specific frequency range, and thus an equalized adjustment of an audio spectrum is achieved. In the present example, different frequency points of the predicted speech signals are multiplied by different coefficients to achieve a more natural auditory perception.

In the present example, a preprocessed signal that meets a model input requirement is obtained by preprocessing the external audio signals before using the noise reduction model, and then the output adjustment can be performed on the predicted speech signals output by the model to improve the output quality of the predicted speech signals.

In another example, the output adjustment may further include performing the output adjustment on the predicted speech signals according to a content playing state.

The content playing state refers to a state in which the user uses the headphone to play audio contents. The content playing state can be divided into a regular-rhythm playing state, a slow-rhythm playing state, a strong-rhythm music state, a phone calling state, a music playing state, a video playing state, a learning resource playing state, and the like.

For example, when the content playing state is the slow-rhythm playing state, a rhythm of the predicted speech signals may be increased so as to form a distinction from a currently played slow-rhythm speech content and highlight an ambient audio of concern selected for transparent transmission.

In another example, when the content playing state is the strong-rhythm music state, the volume of the predicted speech signals may be increased, so that the ambient audio of concern selected for transparent transmission can be perceived by the user.

In another example, the at least one target type of audio signals includes human voices. In the present example, the noise reduction model is used to perform the noise reduction processing on non-human voices, such as speech sounds, public address announcement sounds, and honking sounds, in the external audio signals, and human voices in the external audio signals are retained.

In another example, the at least one target type of audio signals includes human voices and environment-related sounds of concern. The environment-related sounds of concern are sounds with which the user is concerned about in a headphone usage environment. The environment-related sounds of concern may be set by the user at the time of use. Sounds of concern in different environments may also be preset, and during the use of headphone, environment-related sounds of concern can be determined by identifying a headphone usage environment. In the present example, the noise reduction model is used to perform the noise reduction processing on non-human voices and non-sounds of concern in the external audio signals while human voices and sounds of concern in the external audio signals are retained. For example, in a headphone usage environment, corresponding sounds of concern are horn sounds. Thus, in this environment, the first transparent transmission link outputs human voices and horn sounds.

In another example, the at least one target type of audio signals includes environment-related sounds of concern. The environment-related sounds of concern are sounds with which the user is concerned in a headphone usage environment. The environment-related sounds of concern may be set by the user at the time of use. Sounds of concern in different environments may also be preset, and during the use of headphone, environment-related sounds of concern can be determined by identifying a headphone usage environment. In the present example, the noise reduction model is used to perform the noise reduction processing on non-sounds of concern in the external audio signals, and sounds of concern in the external audio signals are retained. For example, when the headphone usage environment is a station waiting environment, corresponding sounds of concern are public address announcements. Thus, in this environment, the first transparent transmission link outputs public address announcements.

In another example, a method of determining the environment-related sounds of concern includes: determining an application environment of the headphone; and acquiring a preset sound of concern corresponding to the application environment.

The application environment of the headphone may include at least one of a playing environment and an application environment of the headphone, and the application environment refers to an external environment where the user uses the headphone. According to the type of usage environment, the application environment can be divided into an indoor environment, an outdoor environment, a road traffic environment, a station waiting environment, a flight waiting environment, and a public transportation environment. The playing environment is related to an application program currently applied to the headphone or terminal, and can be divided into a sports environment, a phone calling environment, a music playing environment, a video playing environment, a learning resource playing environment, and the like according to the application program.

The application environment may be determined according to at least one of the playing environment and the application environment where the headphone is used.

A mapping relationship between application environments and types of sounds of concern is preset, and corresponding sounds of concern are determined based on each application environment. A mapping relationship table of the application environments and the sounds of concern can be preset according to experiences, and can also be set by the user according to personal needs. For example, the user can make adjustments based on a default application environment and sounds of concern according to personal needs.

In an example, at least one of environment data, audio data, position data, and application data may be acquired by a terminal device connected to the headphone, and an application environment is determined and transmitted to the headphone which then determines sounds of concern based on the above data. Alternatively, at least one of environment data, audio data, position data, and application data may be acquired by the terminal device connected to the headphone, and transmitted to the headphone which then determines an application environment based on the above data. When acquiring an application scene, the headphone determines sounds of concern corresponding to the current application environment based on the mapping relationship between the application environments and the sounds of concern.

The mapping relationship table of application environments and sounds of concern according to an example is shown in Table 1.

TABLE 1
Mapping relationship table of application
environments and sounds of concern

| | |
|---|---|
| Indoor environment | Human voices |
| Road traffic environment | Horn sounds of vehicles |
| Station waiting environment | Sounds of public address |
| | announcements |
| Public transportation environment | Arrival announcement sounds |
| Sport environment and outdoor | Horn sounds of vehicles and |
| environment | human voices |
| Phone calling environment and | Horn sounds of vehicles and |
| outdoor environment | human voices |
| Music playing environment and | Horn sounds of vehicles and |
| outdoor environment | human voices |
| Video playing environment and | Horn sounds of vehicles and |
| outdoor environment | human voices |

In the present example, the sounds of concern to be transparently transmitted are determined according to the application environment, and can be transparently transmitted to the user and adaptively become ambient sounds of concern according to the application environment.

In an example, the application environment may be acquired by user settings, and specifically, the application scene of the headphone configured by an environment setting interface may be acquired. A headphone control application program provides an environment setting interface as shown in FIG. 5. The terminal responds to the application environment selected by the user on the environment setting interface and transmits the selected application environment to the headphone.

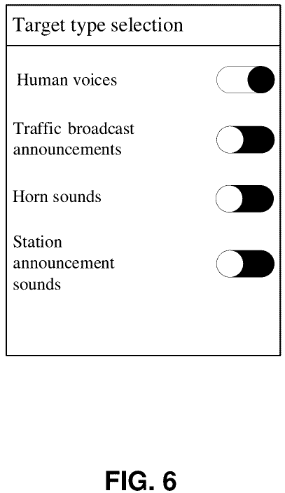

In an example, at least one target type of audio signals that the user actually wants to perceive may also be set by the user. In an example, the terminal device connected to the headphone is installed with an application program for controlling the headphone, and the application program provides a transparent transmission type setting interface. This interface provides a plurality of selectable transparent transmission types of audio signals to be transparently transmitted, and the user can select a target type on the transparent transmission type setting interface. The transparent transmission type setting interface according to an example may be shown in FIG. 6. The terminal responds to the target type, which is selected by the user on the transparent transmission type setting interface, of audio signals to be transparently transmitted, and transmits the selected target type to the headphone. The headphone performs the noise reduction processing on a non-target-type audio signal in external audio signals to obtain a noise-reduced audio signal. For example, in the station waiting environment, the user can select public address announcements as the target type via an application program of the terminal. Thus, when the headphone is used, selective transparent transmission of public address announcements may be achieved.

In an example, a plurality of target types of audio signals to be transparently transmitted may be determined based on user requirements in a development stage, and the plurality of target types may be set as a default configuration. In practical application, the noise reduction processing is performed on the non-target-type audio signal in the external audio signals to obtain a plurality of audio signals of concern to be transparently transmitted. In this example, the headphone can transparently transmit audio signals of default target types. The audio signals of default target types may include human voices, public address announcements in a transportation environment, horn sounds in a traffic environment, public address announcements in a flight waiting environment or a station waiting environment, and the like. The audio signals of a plurality of target types can adapt to a plurality of environments, and when the environment contains audio signals of a target type, the user performs selective transparent transmission on the audio signals of the target type.

In another example, the headphone control method further includes: performing the step of simultaneously turning on the active noise cancellation link and the first transparent transmission link when a trigger command of a selective transparent transmission mode is acquired.

In the present example, after receiving the trigger command of the selective transparent transmission mode, the step of simultaneously turning on the active noise cancellation link and the first transparent transmission link is performed to achieve the selective transparent transmission of the target-type audio signal.

The selective transparent transmission mode refers to transparent transmission of a speech signal with which the user is concerned while the active noise cancellation is performed. The selective transparent transmission mode not only achieves the active noise cancellation, but also achieves the selective transparent transmission of speech signals with which the user is concerned. The selective transparent transmission mode may be triggered by an operation on the headphone by the user. In an example, a touch button is provided on the headphone and is used to switch among a plurality of operating modes. When there is a need to be concerned with specific sounds in the external environment, the user can operate the touch button to trigger the selective transparent transmission mode, and the headphone responds to the trigger command of the selective transparent transmission mode to operate the selective transparent transmission mode. The selective transparent transmission mode may also be triggered when the headphone or terminal detects being in a particular environment. When the headphone or terminal determines environment features based on the acquired environment data, audio data, position data, motion data, and the like, the selective transparent transmission mode is triggered when the headphone or terminal is in the target environment. The target environment may include a road traffic environment, a station waiting environment, a flight waiting environment, a public transportation environment, and the like.

In the present example, after the selective transparent transmission mode is triggered, the selective transparent transmission of the target-type audio signal is achieved. The selective transparent transmission mode may be manually triggered, or may be triggered when the headphone or terminal detects that environment features satisfy a triggering condition.

The headphone according to the disclosure can provide three operating modes including a complete transparent transmission mode, a selective transparent transmission mode, and an active noise cancellation mode.

In another example, the headphone control method further includes: in response to a trigger command of the active noise cancellation mode, performing the active noise cancellation processing on the external audio signals by the active noise cancellation link to obtain anti-noise signals, and playing the anti-noise signals by the speaker.

The active noise cancellation mode refers to blocking all ambient sounds by running an active noise cancellation algorithm. The active noise cancellation mode can satisfy a need of the user for high-quality noise reduction. In an example, a touch button is provided on the headphone and is used to switch among a plurality of operating modes. When there is a need for active noise cancellation, the user can operate this button to trigger the active noise cancellation mode, and the headphone responds to the trigger command of the active noise cancellation mode to operate the active noise cancellation mode. The active noise cancellation mode may also be triggered when the headphone or terminal detects being in a particular environment. When the headphone or terminal determines environment features based on the acquired environment data, audio data, position data, motion data, and the like, the selective transparent transmission mode is triggered when the headphone or terminal is in the target environment. The target environment may include a safety environment or a specific playing environment, such as a playing environment of learning audio and videos.

In the present example, by triggering the active noise cancellation mode, the need of the user for high-quality noise reduction in the headphone can be satisfied.

In another example, the headphone control method further includes: turning on a second transparent transmission link in response to a switching command of the complete transparent transmission mode; acquiring external audio signals; and performing filtering processing on the external audio signals by the second transparent transmission link, and playing the filtered external audio signals by the speaker.

As mentioned earlier, the active noise cancellation mode blocks all ambient sounds and offers a high-quality noise reduction effect for the user. However, at the same time, the active noise cancellation mode also causes that the user cannot clearly hear or cannot hear all the ambient sounds, including horn sounds, sounds of vehicles passing by, key information sources of people talking around them, and the like. As a result, the user cannot keep real-time contact with the external environment, and this affects pace of life and even personal safety. In the present example, in addition to the first transparent transmission link, the second transparent transmission link is further included. In the complete transparent transmission mode, the filtering processing is performed on the external audio signals by the second transparent transmission link, and the filtered external audio signals are played by the speaker. In other words, in the complete transparent transmission mode, all the ambient sounds are accurately transmitted to the headphone, so that the user gains an auditory perception as if not wearing the headphone.

In an example, in the selective transparent transmission mode, the active noise cancellation processing is performed on the external audio signals by the active noise cancellation link to obtain anti-noise signals which can cancel out the external audio signals and achieve active noise cancellation. At the same time, the noise reduction processing is performed on the non-target-type audio signal in the external audio signals by the first transparent transmission link, and the target-type audio signal is retained. Thus, the target-type audio signal finally reaches the ear of the user, and the target-type audio signal of concern from outside is retained while the user enjoys a high-quality noise reduction effect of the active noise cancellation, so that the user can perceive ambient information. Taking audio signals of concern including human voices as an example, the user can also pay attention to external people and better communicates with the external people while enjoying the high-quality noise reduction effect of the active noise cancellation.

In another example, the headphone control method further includes: acquiring an application environment; and controlling the headphone to switch among operating modes when a change in the application environment triggers a change in the headphone operating modes, in which the operating modes include at least two of the selective transparent transmission mode, the active noise cancellation mode, and the complete transparent transmission mode.

In an example, at least one of environment data, audio data, position data, and application data may be acquired by the terminal device connected to the headphone, and an application environment is determined and transmitted to the headphone which then determines the type based on the above data. Alternatively, at least one of environment data, audio data, position data, and application data may be acquired by the terminal device connected to the headphone, and transmitted to the headphone which then determines an application environment based on the above data. When an application environment is acquired, the headphone monitors whether switching among the headphone operating modes is triggered based on the application environment.

Specifically, a mapping relationship between the application environments and the headphone operating modes may be set, and when the headphone operating mode changes due to a change in the application environment, switching among the headphone operating modes is performed.

A mapping relationship table of the application environments and the headphone operating modes according to an example is shown in Table 2.

TABLE 2
Mapping relationship table of application
environments and headphone operating modes

| | |
|---|---|
| Quiet indoor environment | Active noise cancellation mode |
| Indoor environment where | Selective transparent |
| someone speaks | transmission mode |
| Road traffic environment | Selective transparent |
| | transmission mode |
| Station waiting environment | Selective transparent |
| | transmission mode |
| Public transportation | Selective transparent |
| environment | transmission mode |
| Sport environment and | Selective transparent |
| outdoor environment | transmission mode |
| Noisy environment | Complete transparent |
| | transmission mode |

In order to more accurately adapt to a headphone usage mode required by the user, a touch button can be provided on the headphone from a perspective of convenience of operation. When the user is in a particularly noisy environment and does not want to hear anything, the user can operate the touch button to select the active noise cancellation mode. When the user wants to completely control the external environment during the use of headphone, the user can operate the touch button to select the complete transparent transmission mode. When the user wants to reduce noise and slightly grasp the external environment, the user can operate the touch button to select the selective transparent transmission mode.

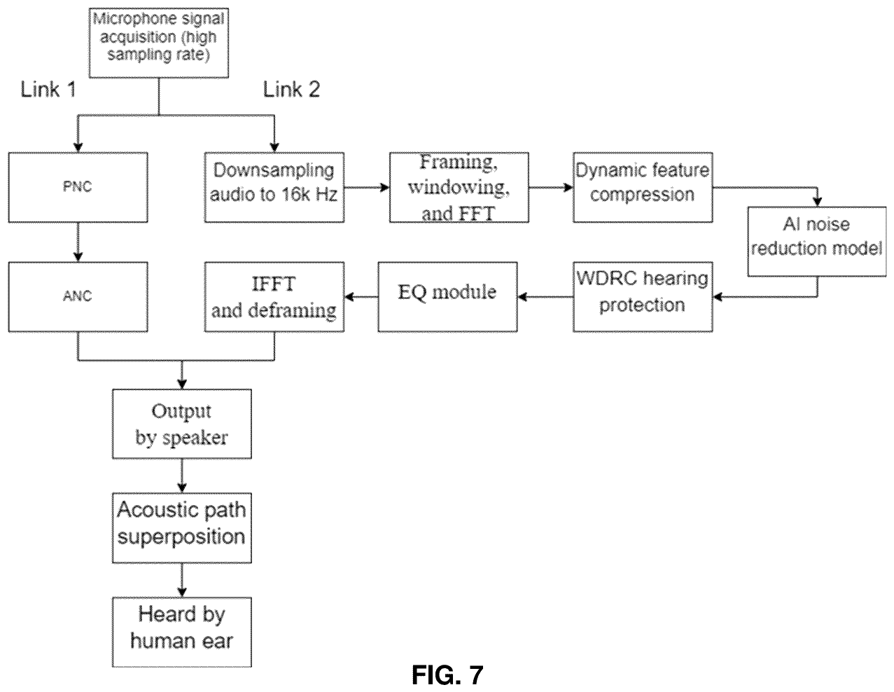

In an example, the headphone control method is shown in FIG. 7, and the implementation of the selective transparent transmission mode adopts two signal processing links of the headphone.

A signal processing link 1 performs active noise cancellation, and a signal processing link 2 performs noise reduction processing on a non-target-type audio signal in external audio signals, so that selective transparent transmission of a target-type audio signal is achieved.

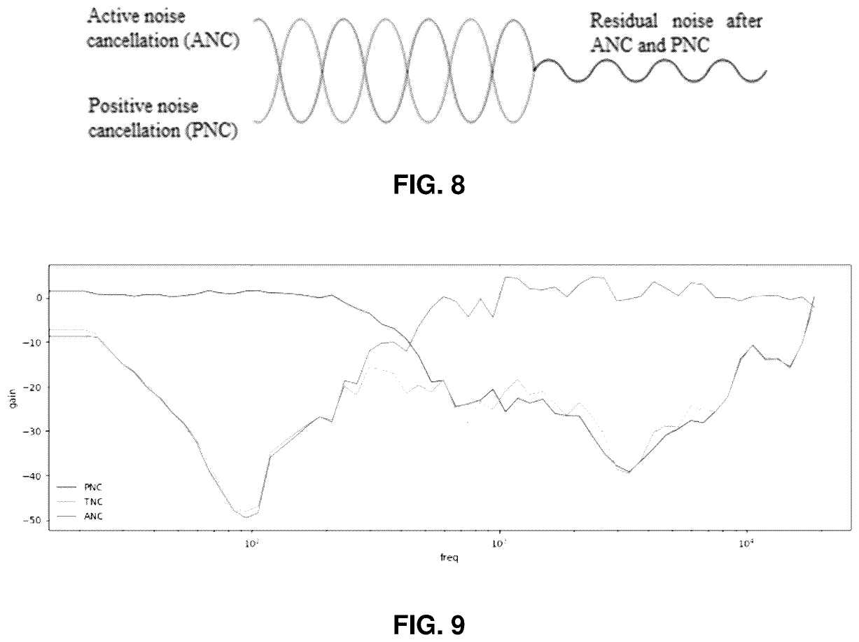

As shown in FIG. 7, the processing link 1 includes passive noise cancellation and active noise cancellation. PNC refers to the passive noise cancellation of the headphone, and a principle of passive noise cancellation of headphones is based on the principle of physical isolation. The passive noise cancellation does not rely on electronic technology or active disturbance, but reduces transmission of ambient noise with structures and materials of the headphone itself. However, the passive noise cancellation technology has strong attenuation of high-frequency sounds, but low attenuation of low-frequency noise. Therefore, active noise cancellation (ANC) can be turned on. A principle of active noise cancellation of headphones is to actively detect, analyze and block ambient noise by using electronic technology and the built-in microphone, and thus noise disturbance is reduced. A result of the active noise cancellation is shown in FIG. 8.

The active noise cancellation includes the following steps.

Step 1, picking up sounds by a microphone. The microphone is located outside the headphone or inside earmuffs so as to be as close as possible to the user's ears. The built-in microphone of the headphone captures ambient noise signals in the external environment, including aircraft engine sounds, traffic noise, and the like. The passive noise cancellation (PNC) can be used for microphone pickup to improve pickup quality. A principle of passive noise cancellation of a headphone is based on a principle of physical isolation. The passive noise cancellation does not rely on electronic technology or active disturbance, but reduces transmission of ambient noise with structures and materials of the headphone itself. The passive noise cancellation can be achieved from aspects such as an earmuff structure, a material for ear cushions, and a sound insulation material for the headphone.

Step 2, performing signal processing. External audio signals captured by the microphone are sent to the circuit system of the headphone for processing. A series of digital signal processing algorithms including filtering, amplification, phase adjustment and other operations are performed on these signals. Noise analysis refers to spectrum analysis and feature extraction for the processed noise signals. These analyses are used to identify features of noise, such as frequency components, amplitude, and phase, to understand features of the external audio signals for further processing.

Step 3, generating anti-phase signals. According to the analysis of the external audio signals, the circuit system of the headphone generates a sound wave signal in a phase opposite to that of the external audio signal, which is called an anti-phase signal or anti-noise signal. This signal is in the phase opposite to that of the external audio signal to achieve an effect of interference and noise cancellation.

Step 4, mixing and playing the anti-phase signals. The generated anti-phase signals are played by the speaker of the headphone. Since the anti-phase signals have a phase opposite to that of the external audio signals, interference occurs to reduce or cancel out noise signals, and thus sounds to be heard by the user are clearer and undisturbed.

The active noise cancellation technology relies on a sophisticated signal processing and feedback system, and can analyze and cancel out external audio signals in real time with a high sampling rate. The active noise cancellation is especially suitable for eliminating low-frequency noise, but has a relatively poor suppressing effect on high-frequency noise. Since the passive noise cancellation of headphones is especially suitable for suppression of high-frequency noise, but has poor performance for low-frequency noise, the active noise cancellation technology is usually combined with the passive noise cancellation technology of headphones to offer a better noise reduction effect and a better auditory perception.

As shown in FIG. 7, processing performed by the signal processing link 2 includes the following steps:
step 1, downsampling the acquired audio signals to 16 kHz for processing with the noise reduction model;
step 2: performing framing, windowing, and FFT processing;
step 3, performing dynamic feature compression processing;
step 4, using the AI noise reduction model to perform the noise reduction processing on the non-target-type audio signal in the external audio signals and obtain the noise-reduced audio signal;
step 5, adopting WDRC to perform volume adjustment processing on the noise-reduced audio signal for protecting hearing;
step 6, performing equalization (EQ) processing on audio processed by WDRC;
step 7, perform IFFT and deframing processing; and
step 8, outputting audio signals by the speaker.

By processing of the processing link 1, sounds may be suppressed a small amount, but by processing of the processing link 2, sounds may be louder than when processed by the processing link 1. When the active noise cancellation and the transparent transmission are simultaneously performed, due to a hearing masking effect, a human ear cannot perceive the sounds processed by the processing link 1 at low delay, and thus the user may only perceive the audio signal of the retained target type perceptually. If the active noise cancellation is not performed simultaneously, a sound volume level of the link 1 may not be much different from that of the link 2, and the human ear could perceive a drag sound. Thus, a noise reduction capability of the processing link 1 can be important. The noise reduction capability of the processing link 1 (ANC+PNC) in an 8K frequency band may be as low as possible. FIG. 9 shows ANC, PNC, and TNC curves of a certain headphone.

The headphone control method according to the disclosure can provide a selective transparent transmission mode between the active noise cancellation mode and the complete transparent transmission mode to perform selective transparent transmission on target ambient sounds. In this mode, an auditory perception of not being able to hear anything after turning on the active noise cancellation mode can be avoided, and a polarized auditory perception that everything can be heard after turning on the complete transparent transmission mode can also be avoided. In this mode, ambient noise can be blocked, and ambient speech signals that the user is concerned with can be heard clearly at the same time.

It should be understood that although the individual steps in the flowcharts involved in the examples described above are shown sequentially as indicated by the arrows, these steps are not necessarily executed sequentially in the order indicated by the arrows. Unless expressly stated herein, there is no strict order limitation on the execution of these steps, and these steps may be executed in other orders. Moreover, at least a portion of the steps in the flowchart involved in the examples described above may include multiple steps or multiple phases, which are not necessarily executed to completion at the same time but may be executed at different times, and the order in which these steps or phases are executed is not necessarily sequential but may be performed in conjunction with at least a portion of the other steps or of at least a portion of the steps or phases in the other steps. They may be performed in turn or alternately with other steps or with at least some of the steps or phases of other steps.

Based on the same inventive conception, the examples of the present disclosure also provide a headphone control device for realizing the above-described headphone control method. The solutions to the problems provided by the respective devices are similar to the solutions associated with the above-described method, so the specific features in the respective device examples provided below can be found in the above-described aspects of the method, and will not be repeated herein.

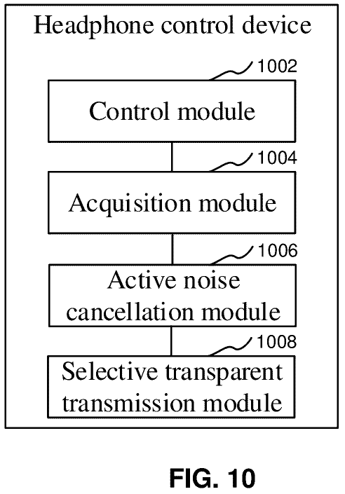

An example provides a headphone control device as shown in FIG. 10, including:
a control module 1002 configured to simultaneously turn on an active noise cancellation link and a first transparent transmission link;
an acquisition module 1004 configured to acquire external audio signals;
an active noise cancellation module 1006 configured to perform active noise cancellation processing on the external audio signals by the active noise cancellation link to obtain anti-noise signals, and play the anti-noise signals by a speaker; and
a selective transparent transmission module 1008 configured to perform noise reduction processing on a non-target-type audio signal in the external audio signals by the first transparent transmission link to obtain a noise-reduced audio signal, and play the noise-reduced audio signal by the speaker.

In another example, the selective transparent transmission module includes:
an ambient sound type determining module configured to determine at least one target type of audio signals to be transparently transmitted; and
a noise reduction processing module configured to perform the noise reduction processing on the non-target-type audio signal in the external audio signals using the noise reduction model to obtain the noise-reduced audio signal.

In another example, the headphone control device further includes an adjustment module configured to perform an output adjustment on the noise-reduced audio signal to obtain an adjusted noise-reduced audio signal, the output adjustment including at least one of a volume adjustment and an audio equalization adjustment.

In another example, an ambient sound type determining module is configured to acquire environment features; determining at least one target type of audio signals corresponding to the environment features, or acquiring at least one target type of audio signals selected by an interface of the target-type audio signals.

In another example, the at least one target type of audio signals includes human voices, or the at least one target type of audio signals includes human voices and environment-related sounds of concern, or the at least one target type of audio signals includes environment-related sounds of concern.

In another example, the headphone control device further includes an environment determining module configured to determine an application environment of the headphone; and a sound of concern determining module configured to acquire a preset sound of concern corresponding to the application environment.

In another example, the sound of concern determining module is configured to determine an application environment of the headphone according to the external audio signals, or acquire an application environment of the headphone configured by an environment setting interface.

In another example, the selective transparent transmission module is configured to acquire at least one target type of audio signals to be transparently transmitted by a target type setting interface.

In another example, the control module is configured to perform the step of simultaneously turning on the active noise cancellation link and the first transparent transmission link when a trigger command of a selective transparent transmission mode is acquired.

In another example, the headphone control device further includes a complete transparent transmission module configured to turn on a second transparent transmission link in response to a switching command of a complete transparent transmission mode; acquire external audio signals; and perform filtering processing on the external audio signals by the second transparent transmission link, and play the filtered external audio signals by the speaker.

The various modules in the above headphone control device may be realized in whole or in part by software, hardware and combinations thereof. Each of the above modules may be embedded in or independent of a processor in a computer device in the form of hardware, or may be stored in a memory in the computer device in the form of software so as to be invoked by the processor to perform the operations corresponding to each of the above modules.

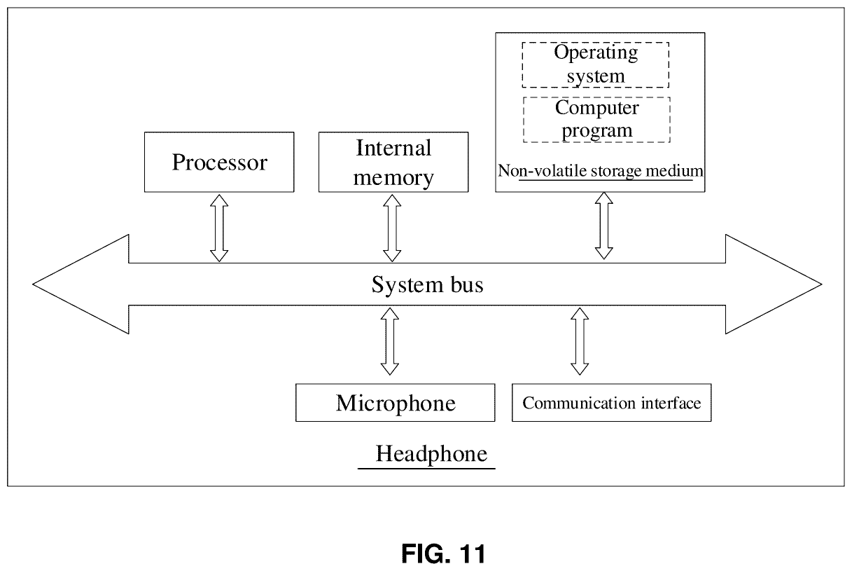

In an example, a headphone is provided, and an internal structure diagram thereof may be as shown in FIG. 11. The headphone includes a processor, a memory, and a microphone that may be connected via a system bus. The processor of the headphone may be used to provide computing and control capabilities. The memory of the headphone may include a non-volatile storage medium and an internal memory. The non-volatile storage medium may store an operating system and a computer program. The internal memory can provide an environment for operations of the operating system and the computer program in the non-volatile storage medium. A communication interface of the headphone may be used for wired or wireless communication with an external terminal, and the wireless communication can be achieved via WIFI, a mobile cellular network, near-field communication (NFC), or other technologies. When executed by the processor, the computer program can implement a headphone control method.

Those skilled in the art may understand that the structure shown in FIG. 11 is merely a block diagram of a partial structure associated with the disclosure and is not intended to limit the headphone to which the disclosure is applied. A specific headphone may include more or fewer components than those shown in the drawing, or may combine certain components, or may have a different arrangement of components.

In an example, a non-transitory computer-readable storage medium is provided, in which a computer program is stored. When executed by the processor, the computer program executes steps according to the above-described examples.

In an example, a computer program product including a computer program is provided. When executed by the processor, the computer program executes steps according to the above-described examples.

Those of ordinary skills in the art may understand that all or part of processes in the methods according to the above-described examples can be implemented by a computer program instructing related hardware. The computer program may be stored in a non-volatile computer-readable storage medium, and when the computer program is executed, methods according to the above-described examples may be performed. Any reference to memory, database, or other medium used in the examples provided by the disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache, or the like. The RAM may be in various different forms, such as a static random access memory (SRAM) or a dynamic random access memory (DRAM). The database according to the examples provided by the disclosure may include at least one of a relational database and a non-relational database. The non-relational database may include a blockchain-based distributed database or the like, which is not limited herein. The processor according to the examples provided by the disclosure may be a general-purpose processor, a central processing unit, a graphics processor, a digital signal processor, a programmable logic unit, a data processing logic unit based on quantum computing, and the like, which is not limited herein.

The various technical features of the above examples can be combined in any way, and all possible combinations of the various technical features of the above examples have not been described for the sake of brevity; however, as long as there is no contradiction in the combinations of these technical features, they should be considered to be within the scope of the present specification.

The above examples describe only several illustrative implementations of the present disclosure, and their descriptions may be specific and detailed, and should not be construed as limitations to the patent scope of the present disclosure. It should be noted that those of ordinary skill in the art can make some variations and improvements without departing from the concept of the present disclosure, and these variations and improvements all fall within the scope of the present disclosure. Therefore, the patent protection scope of the present disclosure should be determined based on the claims.

What is claimed is:

1. A headphone control method for controlling output of a noise cancelling headphone to allow a user to perceive ambient sounds, the method comprising:
simultaneously turning on an active noise cancellation link and a first transparent transmission link;
acquiring, by a microphone, external audio signals;
performing, by the active noise cancellation link, active noise cancellation on the external audio signals to obtain anti-noise signals;
outputting, via a speaker, the anti-noise signals;
performing, by the first transparent transmission link, noise reduction on a non-target-type audio signal in the external audio signals to obtain a noise-reduced audio signal, which corresponds to predicted speech signals of target-type audio signals; and
outputting, via the speaker, the noise-reduced audio signal, which corresponds to the predicted speech signals.

2. The headphone control method according to claim 1, wherein the first transparent transmission link comprises a noise reduction model, which is trained by a training set including input signals with noise and corresponding target-type audio signals for different target-type audio signals, the target-type audio signals being labeled based on the input signals with noise, and wherein the first transparent transmission link performing noise reduction on a non-target-type audio signal in the external audio signals to obtain a noise-reduced audio signal comprises:
receiving an input of at least one target type of audio signals to be transparently transmitted; and
performing the noise reduction on the non-target-type audio signal in the external audio signals, based on the noise reduction model to remove ambient noise other than the target-type audio signal to obtain the noise-reduced audio signal.

3. The headphone control method according to claim 2, after performing the noise reduction on the non-target-type audio signal in the external audio signals based on the noise reduction model to obtain the noise-reduced audio signal, the method further comprising:
performing an output adjustment on the noise-reduced audio signal, which corresponds to the predicted speech signals, to obtain an adjusted noise-reduced audio signal, the output adjustment comprising at least one of a volume adjustment and an audio equalization adjustment for the predicted speech signals,
wherein outputting the noise-reduced audio signal comprises outputting, via the speaker, the adjusted noise-reduced audio signal, which corresponds to the adjusted predicted speech signals.

4. The headphone control method according to claim 2, wherein the at least one target type of audio signals comprises at least one of human voices, or sounds associated with a particular environment.

5. The headphone control method according to claim 2, further comprising determining sounds associated with a particular environment including:
determining an application environment of the headphone; and
acquiring a preset sound corresponding to the application environment.

6. The headphone control method according to claim 5, wherein the determining the application environment of the headphone comprises:
determining an application environment of the headphone according to the external audio signals, or
acquiring an application environment of the headphone selected via an environment setting interface.

7. The headphone control method according to claim 2, wherein receiving the input of at least one target type of audio signals to be transparently transmitted comprises:
acquiring at least one target type of audio signals to be transparently transmitted via an input to a target type setting interface.

8. The headphone control method according to claim 1, wherein the step of simultaneously turning on the active noise cancellation link and the first transparent transmission link is performed based on receiving a trigger command of a selective transparent transmission mode.

9. The headphone control method according to claim 8, further comprising:
turning on a second transparent transmission link based on a switching command of a complete transparent transmission mode;
acquiring second external audio signals; and
filtering the second external audio signals by the second transparent transmission link; and
outputting, via the speaker, the filtered second external audio signals.

10. The headphone control method according to claim 1, further comprising, before performing noise reduction, performing at least one of:
framing the external audio signals by dividing the audio signals into segments;
converting the external audio signals from a time domain to a frequency domain; and
dynamically compressing the external audio signals.

11. A headphone for controlling output to allow a user to perceive ambient sounds, the headphone comprising:
a microphone; and
a controller connected to the microphone, the controller comprising:
a processor, and
a non-transitory computer readable medium storing a computer program that, when executed the processor causes the controller to:
simultaneously initiate operation of an active noise cancellation link and a first transparent transmission link;
acquire, via the microphone, external audio signals;
perform, by the active noise cancellation link, active noise cancellation on the external audio signals to obtain anti-noise signals;
output, via a speaker, the anti-noise signals;
perform, by the first transparent transmission link, noise reduction on a non-target-type audio signal in the external audio signals to obtain a noise-reduced audio signal, which corresponds to predicted speech signals of target-type audio signals; and
output, via the speaker, the noise-reduced audio signal, which corresponds to the predicted speech signals, which corresponds to the predicted speech signals.

12. The headphone according to claim 11, wherein the first transparent transmission link comprises a noise reduction model, which is trained by a training set including input signals with noise and corresponding target-type audio signals for different target-type audio signals and the target-type audio signals being labeled based on the input signals with noise, and wherein the first transparent transmission link performs noise reduction on a non-target-type audio signal in the external audio signals to obtain a noise-reduced audio signal comprises:
receiving an input of at least one target type of audio signals to be transparently transmitted; and
performing the noise reduction on the non-target-type audio signal in the external audio signals, based on the noise reduction model to remove ambient noise other than the target-type audio signal to obtain the noise-reduced audio signal.

13. The headphone according to claim 12, wherein the computer program, when executed, causes the controller, after performing the noise reduction on the non-target-type audio signal in the external audio signals based on the noise reduction model to obtain the noise-reduced audio signal, to:
perform an output adjustment on the noise-reduced audio signal, which corresponds to the predicted speech signals, to obtain an adjusted noise-reduced audio signal, the output adjustment comprising at least one of a volume adjustment and an audio equalization adjustment for the predicted speech signals,
wherein to output the noise-reduced audio signal comprises outputting, via the speaker, the adjusted noise-reduced audio signal, which corresponds to the adjusted predicted speech signals.

14. The headphone according to claim 12, wherein the at least one target type of audio signals comprises at least one of human voices, or sounds associated with a particular environment.

15. The headphone according to claim 12, wherein the computer program, when executed, further causes the controller to determine sounds associated with a particular environment including:
determining an application environment of the headphone; and
acquiring a preset sound corresponding to the application environment.

16. The headphone according to claim 15, wherein the computer program, when executed, causing the controller to determine the application environment of the headphone comprises:
determining an application environment of the headphone according to the external audio signals, or
acquiring an application environment of the headphone selected via an environment setting interface.

17. The headphone according to claim 12, wherein the computer program, when executed, causing the controller to receive the input of at least one target type of audio signals to be transparently transmitted comprises:
acquiring at least one target type of audio signals to be transparently transmitted via an input to a target type setting interface.

18. The headphone according to claim 11, wherein the computer program, when executed, causes the controller to, based on receiving a trigger command of a selective transparent transmission mode, to simultaneously initiate operation of the active noise cancellation link and the first transparent transmission link.

19. The headphone according to claim 18, wherein the computer program, when executed, further causes the controller to:
initiate operation of a second transparent transmission link based on a switching command of a complete transparent transmission mode;
acquire second external audio signals;
filter the second external audio signals by the second transparent transmission link; and
output, via the speaker, the filtered second external audio signals.

20. A non-transitory computer readable medium having a computer program stored thereon which, when executed by a processor, causes a headphone to control output allowing a user to perceive ambient sounds by performing steps of:
simultaneously turning on an active noise cancellation link and a first transparent transmission link;
acquiring, by a microphone, external audio signals;
performing, by the active noise cancellation link, active noise cancellation on the external audio signals to obtain anti-noise signals;
outputting, via a speaker, the anti-noise signals;
performing, by the first transparent transmission link, noise reduction on a non-target-type audio signal in the external audio signals to obtain a noise-reduced audio signal, which corresponds to predicted speech signals of target-type audio signals; and
outputting, via the speaker, the noise-reduced audio signal, which corresponds to the predicted speech signals.
